(19) United States
(12) Patent Application Publication
(10) Pub. No.: US 2002/0010599 A1
(43) Pub. Date: Jan. 24, 2002

(54) Method for targeting insurance policy incentive rewards

(76) Inventor: Michael D. Levison, Atlanta, GA (US)

Correspondence Address: PATREA L. PABST, HOLLAND & KNIGHT LLP, SUITE 2000, ONE ATLANTIC CENTER, 1201 WEST PEACHTREE STREET, N.E., ATLANTA, GA, 30309-3400, US

(21) Appl. No.: 09/760,226

(22) Filed: Jan. 12, 2001

Related U.S. Application Data
(60) Provisional application No. 60/175,748, filed on Jan. 12, 2000.

(51) Int. Cl. G06F 17/60

(52) U.S. Cl. 705/4; 705/14

(57) ABSTRACT

Disclosed is a method for targeting incentive rewards, in the form of an insurance coverage credits to individuals conducting business activities of interest. In a preferred mode, a “Policy Rewards” program implementing the disclosed method provides an incentive for a consumer to conduct more business with a commercial enterprise. Thus, the method can involve the awarding of coverage credits or additional coverage amounts either permanently or for a specified period of time on a wide range of insurance policies in return for a consumer taking agreed upon actions. The method can be implemented in any suitable manner, including completely manually, by manual operation of electronic or mechanical data, or completely automatically. Preferably the method is performed automatically through electronic means.

### CROSS REFERENCE TO RELATED APPLICATIONS

The present application claims priority to U.S. Provisional Patent Application No. 60/175,748, filed Jan. 12, 2000, inventor Michael D. Levison, titled “Method for Targeting Insurance Policy Incentive Rewards.”

### BACKGROUND OF THE INVENTION

Insurance is a system whereby individuals and companies that are concerned about potential hazards pay premiums to an insurance company which reimburses them in the event of a loss. The insurer profits by investing the premiums it receives, and from underwriting gains and losses. Some common forms of insurance cover business risks, automobiles, homes, boats, worker's compensation, and health. Life insurance guarantees payment to the beneficiaries when the insured person dies. In a broad economic sense, insurance transfers risk from individuals to a larger group, which is better able to pay for losses. J. Downes and J. E. Goodman, Dictionary of Finance and Investment Terms, 3^{rd} Edition (Barron's Educational Series, Inc. 1991).

Insurance in some form is as old as historical society. Bottomry contracts were used by merchants of Babylon in 4000 B.C. in which a supplier of capital for a trade venture agreed to cancel the loan if the merchant was robbed. An extra charged was added to the usual rate of interest as a premium for the creditor, to whom the risk of loss by robbery was transferred. The Code of Hammurabi legalized this practice. The Code also provided for the indemnification, by the state or the temple, of a person whose home was destroyed by fire, and for murder or robbery. Encyclopedia Brittanica, 15^{th} edition, vol. 21, p. 753 (Encyclopedia Brittanica, Inc., Chicago, 1998); Encyclopedia Americana, vol. 15, p. 236 (Grolier, Inc. Danbury, Conn. 1996).

There are many methods of classifying insurance. Distinctions are often made according to the risks covered (personal, property, and liability), the perils covered (accident, sickness, old age, fire, windstorm, riot and civil commotion, crime, and others), the losses covered (expense reimbursement or income replacement), the property covered (such as dwellings, buildings, contents, and money) or the policy term (one year, ten years, or the whole of life). Encyclopedia Americana, Id. However, in one classification scheme, insurance might be divided into property insurance, marine insurance, liability insurance, suretyship, and life and health insurance. Encyclopedia Brittanica, Id., at p. 741.

Privately owned insurance firms constitute major industries in the United States and other industrialized nations. However, the present manner of providing insurance is often staid, and so fails to access a larger potential market for insurance. The present invention provides access to that market.

### BRIEF SUMMARY OF THE INVENTION

Disclosed is a method for providing incentive rewards, in the form of an “insurance currency” that can benefit individuals conducting business activities of interest. In a preferred mode, a “Policy Rewards” program implementing the disclosed method provides an incentive for a consumer to conduct business with a commercial enterprise. Thus, the method can involve the awarding of a special currency (coverage credits) that can be used to acquire additional insurance coverage amounts either permanently or for a specified period of time on a wide range of insurance policies in return for a consumer taking agreed upon actions. Alternatively, the currency can be used to purchase new insurance policies as well.

The method can be implemented in any suitable manner, including completely manually, by manual operation of electronic or mechanical data, or completely automatically. Preferably the method is performed automatically through electronic means.

### BRIEF DESCRIPTION OF THE DRAWINGS

FIG. 1 is a flowchart illustrating an entity taking a certain action, and then being awarded a credit for having taking that action. The credit might be used for the purchase of an insurance policy, payment of premiums on an existing policy, or purchase of an additional increment of insurance on an existing policy.

FIG. 2 illustrates an individual taking a certain action, and then being awarded a credit for having taking that action. The credit might be used for the purchase of an insurance policy, payment of premiums on an existing policy, or purchase of an additional increment of insurance on an existing policy.

FIG. 3 illustrates an individual browsing the internet, accessing a certain site, then taking a specified action at the site, and being awarded a credit for taking that action. The credit might take the form of a code sent in an electronic mail message, where the code is redeemable at an insurance company web site for, e.g., purchase of an insurance policy, payment of premiums on an existing policy, or purchase of an additional increment of insurance on an existing policy.

FIG. 4 illustrates an individual visiting a store, making a purchase of a product, and then being awarded a credit towards the purchase of insurance. The product may have imprinted on its label a human or machine-readable code that can be redeemed before an insurance company for insurance credit. Alternatively, the purchaser's identity might be determined at the point of purchase via a questionnaire or the information on his credit or debit card. That information might be transmitted directly to the insurance company of the person, who then receives an insurance credit automatically.

FIG. 5 illustrates an individual using a credit card from a credit card issuer participating in an insurance incentive program. Each purchase made with the credit card results in an insurance credit to the individual.

FIG. 6 illustrates an individual accessing his insurance status, according to the present invention, by means of the internet

### DETAILED DESCRIPTION OF THE INVENTION

Disclosed is a method for targeting incentive rewards, in the form of an insurance currency to individuals conducting business activities of interest. In a preferred mode, a “Policy Rewards” program implementing the disclosed method provides an incentive for a consumer to conduct business with a commercial enterprise. Thus, the method can involve the awarding of additional coverage amounts either permanently or for a specified period of time on a wide range of insurance policies in return for a consumer taking agreed upon actions. In one embodiment, the credit can be used to purchase new insurance policies.

As used herein, the term “insurance currency” refers to the provision of a credit which can be used toward the purchase of insurance. As used herein, an “insurance policy” is a contract for the provision of insurance. As used herein, a “Policy Rewards” program refers to a commercial or governmental enterprise offering insurance credits as described herein in order to induce a third party to take some action desired by the enterprise.

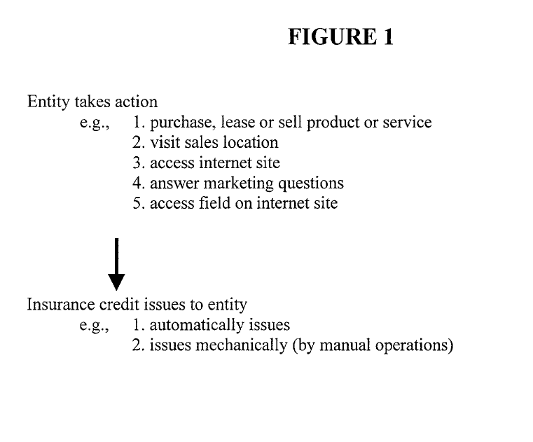

As illustrated in FIG. 1, an entity, such as an individual or business, might take some action. The action can take many forms. For example, the action might be a purchase, lease, or sale of a certain product or service. It might be a visit to a certain sales location, accessing a certain internet site, or accessing certain fields on an internet site. It might even be answering certain marketing questions. The credit redeemable for insurance, or a policy itself, might then issue to the entity. It might issue automatically, or by a manual operation. If the present invention is part of an incentive program, the entity might know before-hand that it might obtain insurance through the performance of a certain action. Alternatively, the insurance might be an unexpected reward for the carrying out of a certain action.

In one embodiment of the invention, a first entity desires a second entity to take some action. The inducement, or incentive, for the second entity to take the action would be the reward of insurance or an insurance credit to the second entity. The award of insurance or an insurance credit might be directly from the first entity, or from a third entity with which the first entity had contracted to perform the function of awarding of insurance. Insurance is generally against the occurrence of certain potential hazards. Such hazards have causative factors. The likelihood of the potential hazard can be reduced if the insured entity takes certain actions to eliminate one or more causative factors. According to one embodiment of the present invention, the action the first entity desires the second entity to take would not be substantially related to the reduction of the likelihood of occurrence of the potential hazard. For example, removal of a trampoline from the yard of a home, or the cessation of smoking tobacco can result in a decrease of home or life insurance premiums paid by an individual. Likewise, removal of diving boards from a hotel pool might reduce insurance premiums paid by the hotel on a policy against company liability for injuries to invitees onto land owned by the hotel. These types of actions do reduce the likelihood of the hazard, by removal of a causative factor.

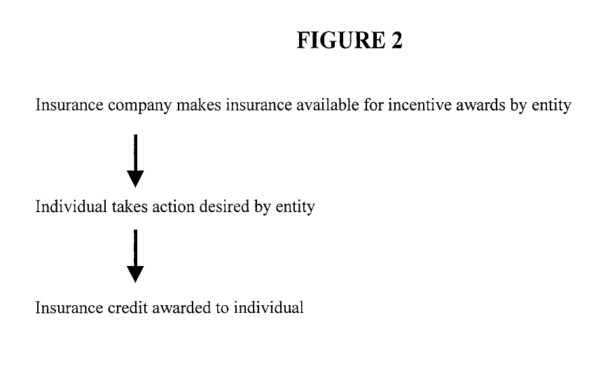

FIG. 2 illustrates one embodiment of the present invention. As shown by FIG. 2, an insurance company might make insurance available for incentive awards by a commercial entity to an individual. The entity might be a single commercial enterprise, or a group of merchants participating in an incentive program authorized by the insurance company. When the individual takes the desired action, insurance currency is awarded to the individual.

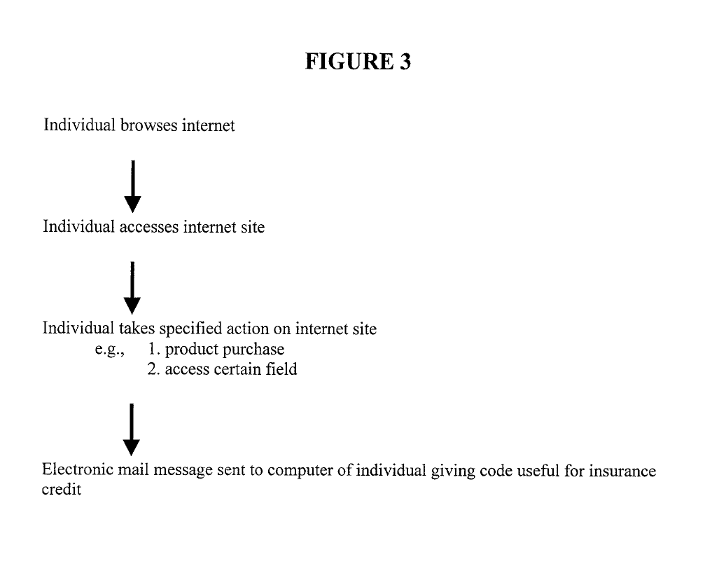

FIG. 3 illustrates one computer-implemented embodiment of the invention. An individual trolls the internet, and accesses an internet site. The individual then takes a specified action on the internet site. That action might be purchasing a (non-insurance) product on the site, accessing a certain field on the internet site, or simply visiting the internet site. This action by the individual prompts the award of either: (1) a credit to purchase insurance, or (2) insurance. The credit might be for the payment of premiums on existing insurance, or for the purchase of additional increments of insurance. In one embodiment of the invention, an electronic mail message might be sent back to the computer of the individual, giving him a code number representing the credit, or representing the policy number of the insurance he has been granted. Alternatively, the individual may have registered for an incentive program with an insurance company, in which case if the internet site is a participating one, an electronic mail message specifying an insurance credit for the individual might be sent directly to the insurance company.

As used herein “increment of insurance”, includes, but is not limited to: an increase in the amount paid to an insurance beneficiary in the case of occurrence of the insured-against potential hazard; a broadening of the types of hazards insured against; an increase in the number or types of beneficiaries; a decrease in the amount deductible from the payment to a beneficiary in the case of occurrence of the insured-against potential hazard; an increase in the term of coverage of an insurance policy; decrease in the number or types of activities by the insured party that preclude the payment of insurance to a beneficiary in the case of occurrence of the insured-against potential hazard.

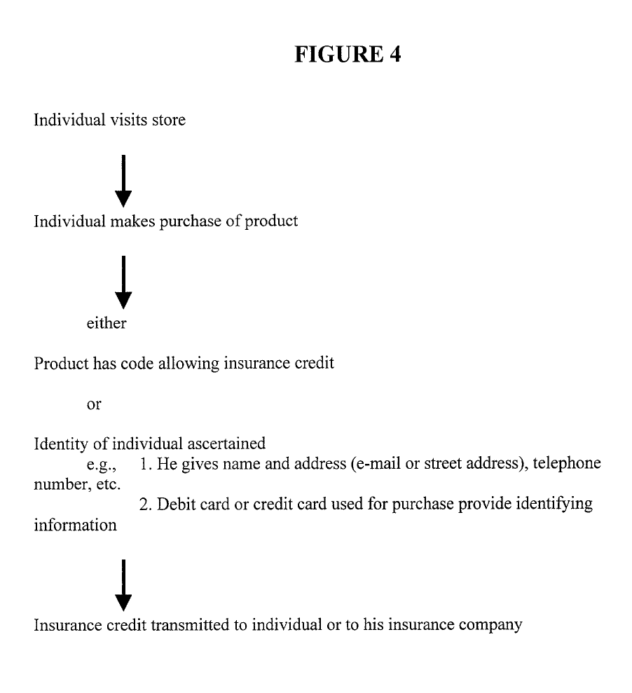

FIG. 4 illustrates an embodiment of the invention involving the purchase by an individual from a store. An individual might make a purchase from a store of a product from a certain manufacturer. Alternatively, it might be the purchase of a product from a certain store, or chain of stores, e.g., Wal-Mart, Inc. The product might have a human or machine-readable code redeemable for insurance credit. Alternatively, the identity of the individual might be divined from a questionnaire, or his credit card or debit card. The credit might transmitted to the individual in the form of a printed paper receipt at the point of purchase, or the merchant might inform the participating insurance company, which would inform the individual of the credit.

Activities that could result in additional coverage awards include, but are not limited to: reading specified advertising, such as emails, responding to advertising, purchasing additional products, keeping a previously purchased product for an agreed upon period of time, and agreeing to try a new product/service on a trial basis.

The disclosed method, implemented as a Policy Rewards programs, may be offered to commercial enterprises in a variety of ways. For example, the program can be completely private labeled to a specific enterprise. This arrangement would be appropriate for an insurance company that wanted to provide “rewards” only for business conducted with them with rewards only being offered in conjunction with their specific products. Another approach would be to participate in the merchant network whereby consumers could earn rewards by transacting business with any of the participating merchants and the insurance currency could be utilized at any of the participating insurance companies. The disclosed method is adaptable to these and numerous other program models.

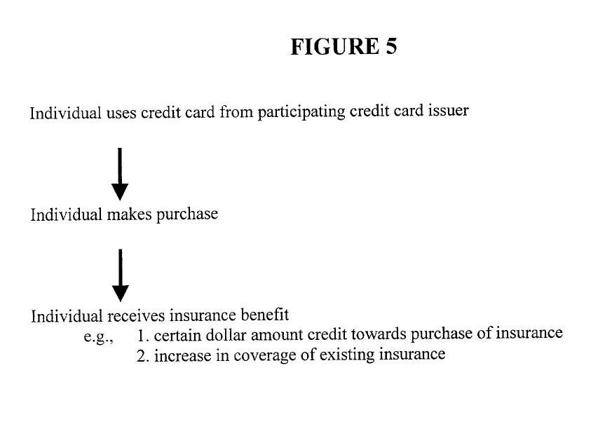

For example, in one embodiment, an entity issuing credit cards might contract with an insurance company. [A credit card is typically a small card containing a means of identification, such as a signature, that authorizes the person named on it to charge goods or services to his account, on which he is billed periodically.] Each purchase made by an individual using the credit card might result in an award to the individual of a certain amount of insurance credit (or currency). The insurance credit might be in the form of a credit towards the purchase of an insurance policy, it might be a credit towards the payment of premiums on an insurance policy, or it might be an insurance policy itself. In one embodiment of the invention, the amount of insurance credit awarded might be based on the price of the goods or services purchased using the credit card. (See FIG. 5). In preferred forms of the method, consumers enrolled in the program would be able to review coverage balances in a “real time” basis at any time (such as by accessing an internet site), and periodic rewards statements would be provided.

In one embodiment of the invention, a debit card or a stored value card might be employed in place of a credit card.

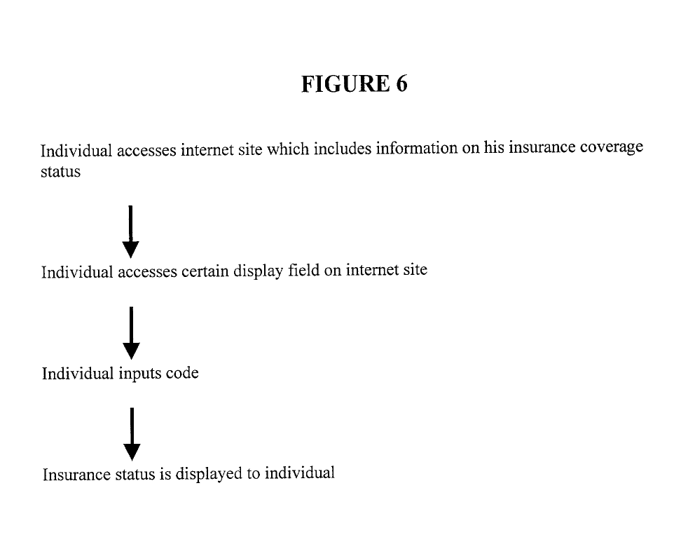

FIG. 6 illustrates an individual accessing his insurance status via an internet site.

Note that in one embodiment of the invention, the insurance credit (or currency) is not an insurance credit for insurance on the product purchased.

The invention may be further understood by reference to the following non-limiting examples.

Example 1

An insurance company might use the disclosed method to encourage its policy holders to conduct business at its web site rather than using the traditional phone, mail or face to face channels (such as premium billings and payments, routine questions, initiating claims, etc). Every transaction that the customer initiates at the web site would be rewarded through the issuance of coverage credits that could be used to buy additional amounts of coverage to the customer's existing policy (or a separate policy provided as a reward) according to a specific schedule.

Example 2

An insurance company would issue coverage credits based on the amount of premium the customer has paid on the insurance policy they previously purchased from the company. For instance, every dollar of premium paid resulted in certain amount of additional credits being issued.

Example 3

A retail store could provide a small insurance policy to a consumer as a bonus or “gift” in conjunction with a purchase of the retailer's product or service. The policy would then be added to, according to a specific schedule, with each additional purchase or other activity that the retailer would like to reward such as conducting business over the retailer's web site rather than using the traditional phone, mail or face-to-face channels (such as placing orders, making payments, routine questions, etc).

Example 4

An insurance agency, representing several insurance companies, would issue coverage credits based on the policies and premium payments made by clients. These credits could be used to pay premiums on existing policies owned by the customer, add coverage to existing policies or to make premium payments on new products.

Example 5

A consumer enrolls in the Policy Rewards Program. This can be done directly with the Policy Rewards program provider or through a participating merchant or a participating insurance company.

A consumer obtains an insurance policy (life, accident, health, auto, homeowners, etc.) either by purchase or gift from a participating merchant. As the policy owning consumer takes the desired actions as specified by the merchant in the program, he/she is awarded with coverage credits. The amounts and duration of the coverage credits may vary depending on the consumer's specific behavior and/or the specifications of the participating merchant or insurance carrier.

It is understood that the disclosed invention is not limited to the particular methodology, protocols, and materials described, as these may vary. It is also to be understood that the terminology used herein is for the purpose of describing particular embodiments only, and is not intended to limit the scope of the present invention which will be limited only by the appended claims.

Unless defined otherwise, all technical and scientific terms used herein have the same meanings as commonly understood by one of skill in the art to which the disclosed invention belongs. Although any methods and materials similar or equivalent to those described herein can be used in the practice or testing of the present invention, the preferred methods, devices, and materials are as described. Publications cited herein and the material for which they are cited are specifically incorporated by reference. Nothing herein is to be construed as an admission that the invention is not entitled to antedate such disclosure by virtue of prior invention.

Those skilled in the art will recognize, or be able to ascertain using no more than routine experimentation, many equivalents to the specific embodiments of the invention described herein. Such equivalents are intended to be encompassed by the following claims.

I claim:

1. A method of targeting an incentive reward to an individual conducting an activity of interest, wherein the incentive reward is an insurance coverage credit that can be used to purchase an insurance policy or pay premiums on an increment of insurance coverage.

2. The method of claim 1 wherein the incentive reward is an increment of insurance coverage.

3. The method of claim 2 wherein the increment of insurance coverage is selected from the group consisting of:
an increment of policy premium or payout;
an increment of the term of coverage

4. The method of claim 1 wherein the activity of interest is a visit to take a desired action such as to make a premium payment, purchase a product, visit a particular store, web site, or web page, or a particular click on a web page.

5. The method of claim 4 wherein the activity of interest is a visit to a particular web site.

6. The method of claim 1 wherein the activity of interest is the purchase of a particular product or the purchase of a product on a particular web site.

7. The method of claim 6 wherein the particular product is purchased via the Internet.

8. The method of claim 1 wherein the incentive reward is credited to the individual automatically when the activity of interest takes place.

9. An insurance system comprising:
an item selected from the group consisting of:
(1) a credit to purchase insurance or pay premiums on insurance; and
(2) insurance
wherein the item is awarded by a first entity, and the insurance is for a second entity, wherein the insurance is against the occurrence of a potential hazard having causative factors;
wherein the first entity awards the item to the second entity in order to induce the second entity to take some action, wherein the action taken has no substantial bearing on reducing the likelihood of occurrence of the causative factors;
and wherein the second entity may or may not have existing insurance.

10. The system of claim 9, wherein the insurance is selected from the group consisting of insurance policies and increments of additional insurance coverage on existing policies.

11. The system of claim 10, wherein the increments of additional coverage are selected from the group consisting of reduction of policy premium payments; increase in term of payment of policy premiums; increase in the term of insurance coverage; increase in types of potential hazards covered by insurance; increase in number of entities covered by insurance; reduction in deductible amounts taken out before policy payouts.

12. The system of claim 9, wherein the first and second entities are chosen from the group consisting of corporeal and intangible entities.

13. The system of claim 10, wherein the second entity is chosen from the group consisting of corporations, partnerships, and individuals.

14. The system of claim 9, wherein the insurance policy is awarded without charge to the second entity.

15. An insurance system comprising awarding of an item to an entity for free, wherein the item is selected from the group consisting of (1) a credit to purchase insurance or pay premiums on insurance; and (2) insurance.

16. An insurance system comprising awarding of an item selected from the group consisting of (1) a credit to purchase an insurance policy; and (2) an insurance policy, wherein the award is made by a first entity to a second entity for reasons selected from the group consisting of:
marketing promotions; encouraging the second entity to use an internet site; purchase of a product by the second entity; lease of a tangible or intangible product by the second entity; use of a service by the second entity.

17. A computer-implemented insurance system comprising:
an item selected from the group consisting of: (1) a credit to purchase insurance or pay premiums on insurance; and (2) insurance
wherein the insurance is awarded by a first entity, and the insurance is for a second entity, and is against the occurrence of a potential hazard having causative factors;
wherein the first entity awards the item to the second entity in order to induce the second entity to take some action, wherein the action taken has no substantial bearing on reducing the likelihood of occurrence of the causative factors.

18. A method of inducing an entity to take a certain action comprising awarding to the entity a credit which may be used to requisition insurance against a potential hazard having certain risk factors, wherein the action does not reduce the likelihood of occurrence of the risk factors.

19. The method of claim 18, wherein the requisition is selected from the group consisting of:
purchase of a new insurance policy; payment of premiums on an existing policy; and payment of premiums on an additional increment of insurance coverage on an existing policy.

20. A method of promotion to an entity of a thing selected from the group consisting of products and services, wherein when the thing is selected by the entity, also awarded to the entity at no cost to the entity is an item selected from the group consisting of (1) a credit to purchase insurance or pay premiums on insurance; and (2) insurance.

21. The method of claim 20, wherein the action is selected from the group consisting of:
make a premium payment; purchase, sell or lease a product or service; visit a particular sales location; access a particular internet site; access a particular location on an internet site.

22. The method of claim 20, wherein the credit is awarded automatically when the action is taken.

23. A method of advertising comprising providing a code redeemable for an item selected from the group consisting of:
(1) a credit to purchase insurance or pay premiums on insurance; and
(2) insurance.

24. A value card system wherein the use on behalf of the credit card holder of the credit card for the purchase, lease, or license of goods or services results in an insurance credit to the holder of the credit card.
